(19) United States
(12) Patent Application Publication
(10) Pub. No.: US 2025/0139848 A1
(43) Pub. Date: May 1, 2025

(54) IMAGE GENERATION METHOD AND RELATED APPARATUS

(71) Applicant: Tencent Technology (Shenzhen) Company Limited, Shenzhen (CN)

(72) Inventors: Ziqi LI, Shenzhen (CN); Pan JI, Shenzhen (CN); Hongdong LI, Shenzhen (CN)

(21) Appl. No.: 19/012,660

(22) Filed: Jan. 7, 2025

(30) Foreign Application Priority Data
Jan. 30, 2023 (CN) 202310116809.X

(51) Int. Cl. G06T 11/00; G06T 7/10

(52) U.S. Cl. CPC G06T 11/00; G06T 7/10; G06T 2207/10028

(57) ABSTRACT

This application provides an image generation method performed by a computer device. The method includes: obtaining a target depth image including a target object in a real scene, and each pixel point in the target depth image having a depth value; segmenting the target depth image based on the depth value corresponding to each pixel point in the target depth image, to obtain a target object template image including a plurality of pixel points corresponding to the target object in the target depth image; obtaining M background images corresponding to a target scene, the target scene being a scene set associated with an image processing model, and M being an integer greater than or equal to 1; and superimposing the target object template image on the M background images, to generate M target scene images, the target scene images being configured for training the image processing model.

### CROSS-REFERENCE TO RELATED APPLICATIONS

This application is a continuation application of PCT Patent Application No. PCT/CN2023/133122, entitled “IMAGE GENERATION METHOD AND RELATED APPARATUS” filed on Nov. 22, 2023, which claims priority to Chinese Patent Application No. 202310116809.X, entitled “IMAGE GENERATION METHOD AND RELATED APPARATUS” filed with the China National Intellectual Property Administration on Jan. 30, 2023, both of which are incorporated herein by reference in their entirety.

### FIELD OF THE TECHNOLOGY

This application relates to the field of artificial intelligence technologies, and in particular, to image generation.

### BACKGROUND OF THE DISCLOSURE

With continuous development of artificial intelligence in image processing technologies, a computer device can perform personalized processing, such as image classification, target detection, image segmentation, and keypoint detection, on an image or a video by using, for example, machine learning technologies, to obtain an image processing result that meets an actual requirement of a user.

During actual application, to improve efficiency and accuracy of image processing, a machine learning network (which is particularly a deep learning network) is usually used to train a large amount of sample data, so as to obtain an image processing model that meets a requirement of an image processing task in a corresponding scenario. In this way, a to-be-processed image in this scenario is processed effectively, to obtain a required image processing result.

However, for some tasks in a new scenario or a new field, there is usually a lack of open-source training sample data. If training sample data is manually collected through a data factory, manual costs are high, efficiency is low, and human factors have a large impact. As a result, the collected training sample data has poor quality, and there is a small amount of valid sample data for training.

### SUMMARY

Embodiments of this application provide an image generation method and a related apparatus. A target depth image that includes a target object is segmented to obtain a target object template image. Then, a large quantity of training images with different backgrounds are generated by superimposing the target object template image on a large quantity of different background images. The large quantity of training images are obtained with minimum costs, quality of each training image is ensured through combination of a target object template and a background, and training efficiency and accuracy of an image processing model are effectively improved.

An aspect of this application provides an image generation method performed by a computer device, including:
obtaining a target depth image, the target depth image including a target object in a real scene, and each pixel point in the target depth image having a depth value;
segmenting the target depth image based on the depth value corresponding to each pixel point in the target depth image, to obtain a target object template image, the target object template image comprising a plurality of pixel points corresponding to the target object in the target depth image;
obtaining M background images corresponding to a target scene, the target scene being a scene set associated with an image processing model, and M being an integer greater than or equal to 1; and
superimposing the target object template image on the M background images, to generate M target scene images, the target scene images being configured for training the image processing model.

Another aspect of this application provides a computer device, including:
a memory, a transceiver, a processor, and a bus system;
the memory being configured to store a computer program;
the processor being configured to execute the computer program in the memory, including performing the method in the foregoing aspect; and
the bus system being configured to connect the memory and the processor, to enable the memory and the processor to communicate.

Another aspect of this application provides a non-transitory computer-readable storage medium, storing a computer program, when the computer program being run on a computer, the computer being enabled to perform the method in the foregoing aspect.

It can be seen from the foregoing technical solutions that the embodiments of this application have the following advantages:

This application provides an image generation method and a related apparatus. The method includes: first, obtaining a target depth image, the target depth image being configured for presenting a target object in a real scene, and each pixel point in the target depth image having a depth value; then, segmenting the target depth image based on the depth value corresponding to each pixel point, to obtain a target object template image, the target object template image including a pixel point corresponding to the target object in the target depth image; then, obtaining M background images corresponding to a target scene, the target scene being a scene set based on a training task; and finally, superimposing the target object template image on the M background images, to generate M target scene images, the target scene image being configured for presenting the target object in the target scene. The target depth image including the target object is segmented based on a difference between depth values in a foreground and a background, to obtain the accurate target object template image. Then, a large quantity of training images with different backgrounds are generated by superimposing the target object template image on a large quantity of different background images. The large quantity of training images are obtained with minimum costs, quality of each training image is ensured through combination of a target object template and a background, and training efficiency and accuracy of an image processing model are effectively improved.

### BRIEF DESCRIPTION OF THE DRAWINGS

FIG. 1 is a schematic diagram of an architecture of an image generation system according to an embodiment of this application.

FIG. 2 is a flowchart of an image generation method according to an embodiment of this application.

FIG. 3 is a schematic diagram of shooting a target depth image of a target object wearing a first device according to an embodiment of this application.

FIG. 4 is a flowchart of an image generation method according to another embodiment of this application.

FIG. 5 is a flowchart of an image generation method according to another embodiment of this application.

FIG. 6 is a flowchart of an image generation method according to another embodiment of this application.

FIG. 7 is a flowchart of an image generation method according to another embodiment of this application.

FIG. 8 is a flowchart of an image generation method according to another embodiment of this application.

FIG. 9 is a flowchart of an image generation method according to another embodiment of this application.

FIG. 10 is a flowchart of an image generation method according to another embodiment of this application.

FIG. 11 is a flowchart of an image generation method according to another embodiment of this application.

FIG. 12 is a flowchart of an image generation method according to another embodiment of this application.

FIG. 13 is a flowchart of an image generation method according to another embodiment of this application.

FIG. 14 is a flowchart of an image generation method according to still another embodiment of this application.

FIG. 15 is a schematic diagram of target segmentation according to an embodiment of this application.

FIG. 16 is a schematic diagram of a structure of an image generation apparatus according to an embodiment of this application.

FIG. 17 is a schematic diagram of a structure of a server according to an embodiment of this application.

### DESCRIPTION OF EMBODIMENTS

Embodiments of this application provide an image generation method. A target depth image that includes a target object is segmented to obtain a target object template image. Then, a large quantity of training images with different backgrounds are generated by superimposing the target object template image on a large quantity of different background images. The large quantity of training images are obtained with minimum costs, quality of each training image is ensured through combination of a target object template and a background, and training efficiency and accuracy of an image processing model are effectively improved.

In the specification, claims, and accompanying drawings of this application, the terms “first”, “second”, “third”, “fourth”, and the like (if any) are intended to distinguish between similar objects, but do not necessarily indicate a specific order or sequence. Data used in such a way is interchangeable in a proper case, so that the embodiments of this application described herein can be implemented, for example, in a sequence other than the sequence illustrated or described herein. Moreover, the terms “include”, “correspond to”, and any other variants are intended to cover the non-exclusive inclusion. For example, a process, method, system, product, or device that includes a series of steps or units is not necessarily limited to those expressly listed steps or units, but may include other steps or units not expressly listed or inherent to the process, method, system, product, or device.

Artificial Intelligence (AI) is a theory, a method, a technology, and an application system that use a digital computer or a machine controlled by the digital computer to simulate, extend, and expand human intelligence, perceive an environment, obtain knowledge, and use the knowledge to obtain an optimal result. In other words, the artificial intelligence is a comprehensive technology in computer science, to attempt to understand an essence of intelligence, and produce a new intelligent machine that can react in a manner similar to that of human intelligence. The artificial intelligence is to study design principles and implementation methods of various intelligent machines, to enable the machines to have functions of perception, inference, and decision-making.

The artificial intelligence technologies are a comprehensive discipline, and relate to a wide range of fields, including both hardware-level technologies and software-level technologies. Basic technologies of the artificial intelligence usually include technologies such as a sensor, a dedicated artificial intelligence chip, cloud computing, distributed storage, big data processing technologies, an operating/interaction system, and electromechanical integration. Artificial intelligence software technologies mainly include several major directions such as a computer vision (CV), speech processing technologies, natural language processing technologies, and machine learning (ML)/deep learning (DL).

Computer vision (CV): The computer vision is a science for studying how to enable a machine to “see”, and further, refers to using a camera and a computer to replace human eyes in machine vision such as recognizing and measuring a target, and further perform graphics processing, so that an image that is more suitable for the human eyes to observe or transmitted to an instrument for detection is obtained through processing by the computer. In the computer vision, which is a scientific discipline, related theories and technologies are researched, to attempt to establish an artificial intelligence system that can obtain information from an image or multi-dimensional data. The computer vision generally include technologies such as image processing, image recognition, image semantic understanding, image retrieval, optical character recognition (OCR), video processing, video semantic understanding, video content/behavior recognition, three-dimensional (3D) object reconstruction, 3D technologies, virtual reality (VR), augmented reality (AR), synchronous positioning, and map building, and further include common biometric recognition technologies such as facial recognition and fingerprint recognition.

The machine learning (ML) is a discipline in which a plurality of fields intersect, and relates to a plurality of disciplines such as a probability theory, statistics, an approximation theory, convex analysis, and a computational complexity theory. In the machine learning, how a computer simulates or implements learning behaviors of humans is specifically studied, to obtain new knowledge or skills, and reorganize an existing knowledge structure to continuously improve performance of the computer. The machine learning, as a core of the artificial intelligence, is a fundamental way to make the computer intelligent, and is applied throughout various fields of the artificial intelligence. The machine learning and the deep learning usually include technologies such as an artificial neural network, a belief network, reinforcement learning, transfer learning, inductive learning, and demonstration learning.

For ease of understanding the technical solutions provided in the embodiments of this application, some key terms used in the embodiments of this application are first explained herein:

Mixed reality recording is video recording in which a person with a head-mounted device in reality is superimposed on a virtual scene running in the head-mounted device. During use of the augmented reality (AR) or virtual reality (VR), a user needs to wear a device such as a head-mounted device or a handheld device for experience. To show an onlooker the user and visual content seen by the user, the mixed reality recording needs to be performed.

Deep learning (DL) is a new research direction in the field of the machine learning (ML), and is introduced to make the machine learning closer to an initial objective, which is the artificial intelligence (AI). The deep learning is a branch of the machine learning and uses a neural network (NN) as an architecture for training and learning. In this type of method, representation learning is performed on data. Through learning an internal rule and a representation hierarchy of sample data, information obtained in these learning processes greatly helps interpretation of data such as a text, an image, and voice. An ultimate objective of the deep learning is to enable a machine to have analysis and learning capabilities the same as those of a human being, and to recognize the data such as a text, an image, and a voice.

An artificial neural network (ANN), also referred to as a neural network (NN) or a connection model, is an algorithmic mathematical model that simulates a behavioral feature of an animal neural network and perform distributed parallel information processing. This network depends on complexity of a system, and implements information processing by adjusting connection relationships between a large quantity of internal nodes. A structure of the neural network is similar to interconnected neurons in a human brain. An adaptive system can be created through the structure, and is continuously improved during learning.

Body segmentation is a sub-task of semantic segmentation, and is intended to obtain pixels of a person through fine-grained segmentation in an image and output the pixels.

Generalization is a characteristic that represents an ability of a model to perform accurate and stable prediction on a new dataset after learning training data.

A data factory is an organization that annotates data for a fee.

A dataset is a very important factor for a deep learning task. A dataset including training data used for training a deep learning model can directly affect final accuracy and generalization of a trained network to a large extent. For a task in a new field, a dataset of a specific quantity of related tasks is required when a network model is preliminarily verified and when the network model is preliminarily fine-tuned. However, because the dataset is of a task set in the new field, no related open-source dataset can be used.

In a process of creating a dataset in the related art, a most common method is to perform manual collection in a data factory. After a demand and a technology roadmap of this method are finally formed, time and money can be invested in this method. However, for some tasks in a new scenario or a new field, there is usually a lack of open-source training sample data. If training sample data is manually collected through a data factory, manual costs are high, efficiency is low, and human factors have a large impact. As a result, the collected training sample data has poor quality, and there is a small amount of valid sample data for training.

This application provides an image generation method and a related apparatus. A target depth image that includes a target object is segmented to obtain a target object template image. Then, a large quantity of training images with different backgrounds are generated by superimposing the target object template image on a large quantity of different background images. The large quantity of training images are obtained with minimum costs, quality of each training image is ensured through combination of a target object template and a background, and training efficiency and accuracy of an image processing model are effectively improved.

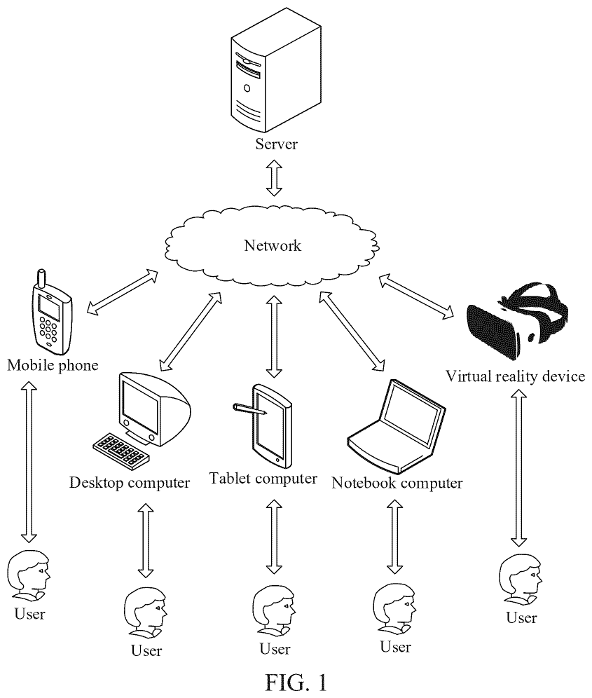

For ease of understanding, FIG. 1 is a diagram of an application environment of the image generation method according to an embodiment of this application. As shown in FIG. 1, the image generation method in this embodiment of this application is applied to an image generation system. The image generation system includes a server and a terminal device. The server may be an independent physical server, or may be a server cluster including a plurality of physical servers or a distributed system. Alternatively, the server may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. The terminal may bean augmented reality (AR) device, a virtual reality (VR) device, a smartphone, a tablet computer, a notebook computer, a desktop computer, a smart speaker, a smartwatch, or the like, but is not limited thereto. The terminal and the server may be directly or indirectly connected through wired or wireless communication. This is not limited in this embodiment of this application.

First, the server obtains a target depth image. The target depth image is configured for presenting a target depth image of a target object wearing a first device in a real scene, and each pixel point in the target depth image has a depth value. Then, the server segments the target depth image based on the depth value corresponding to each pixel point, to obtain a target object template image. The target object template image includes a pixel point of an image corresponding to the target object and obtained through segmentation. Then, the server obtains M background images corresponding to a target scene. The target scene is a scene set based on a training task. Finally, the server superimposes the target object template image on the M background images to generate M target scene images. The target scene image is configured for presenting an image of the target object wearing the first device in the target scene.

The method provided in this embodiment of this application may be applied to a VR scene or a AR scene of a game. The target depth image of the target object (for example, a game player) wearing the first device (for example, a head-mounted VR device or a handheld VR device) in a real scene is captured by using a depth camera. The server obtains the target depth image, and segments the target depth image based on the depth value corresponding to each pixel point in the target depth image, to obtain the target object template image. The target object template image includes the pixel point corresponding to the target object. The server obtains the M background images corresponding to the target scene set based on the training task. The background images are related to a background seen by the target object in the head-mounted VR device (where for example, the scene seen by the target object in the head-mounted VR device is a forest, and the background images are various forest background images). The target object template image is superimposed on the M background images to generate the M target scene images. The target scene image is configured for presenting the image of the target object wearing the first device in the background image. The generated M target scene images may be used as training images to resolve problems of insufficient training samples and poor training sample quality.

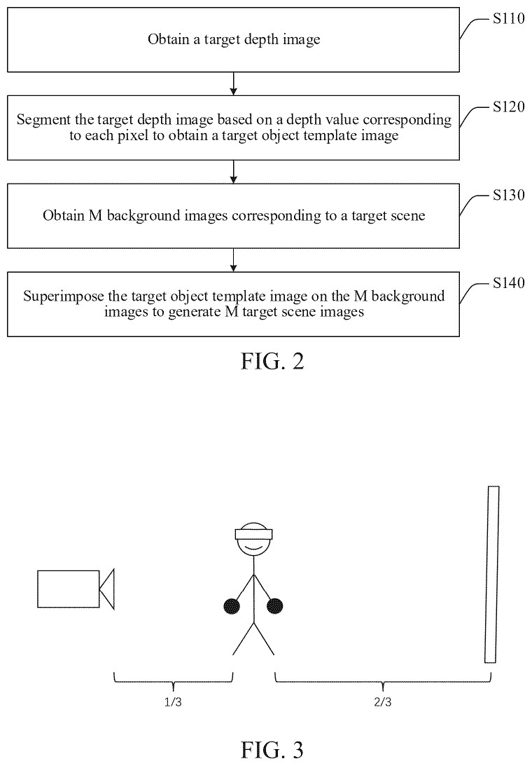

The following describes the image generation method in this application from a perspective of the server. Refer to FIG. 2. The embodiments of this application may be performed by a computer device. The computer device may be, for example, the foregoing terminal device or server.

The image generation method includes S110 to S140. Details are as follows:

S110: Obtain a target depth image.

The target depth image is configured for presenting a target object in a real scene, and each pixel point in the target depth image has a depth value.

In some image generation scenarios, an image related to wearing a device needs to be generated, for example, the target object wearing a first device, such as a user wearing a VR device. In this scenario, the target object in the target depth image needs to wear the first device.

A depth camera obtains a first depth image, and target detection is performed on the first depth image. If the first depth image includes the target object, the first depth image is determined as the target depth image.

The target depth image includes K pixel points, and each pixel point has a depth value. If the target object wearing the first device in the target depth image corresponds to L pixel points, an original background in the target depth image corresponds to K-L pixel points.

The first device may be one or more of wearable devices such as a helmet and a handheld handle. This is not limited in this embodiment of this application.

FIG. 3 is a schematic diagram of shooting the target depth image of the target object wearing the first device. Because the target object is located between the original background and the depth camera, depth values of the L pixel points corresponding to the target object wearing the first device in the shot target depth image are different from depth values of the K-L pixel points corresponding to the original background in the target depth image. Preferably, to ensure that the depth values of the K-L pixel points corresponding to the original background are as same as possible or float in a range close to a value, the original background needs to be set to a plane with a flat surface and without other decoration. To further narrow the floating range of the depth values of the K-L pixel points corresponding to the original background, the depth camera is placed at a maximum capture distance of the depth camera. To ensure that the target object is entirely included in the target depth image and make the target object better distinguished from the original background, the target object wearing the first device is located at ⅔ of a distance between the depth camera and the original background.

S120: Segment the target depth image based on the depth value corresponding to each pixel point, to obtain a target object template image.

The target object template image includes a pixel point of an image corresponding to the target object and obtained through segmentation.

Because the depth value of the pixel point of the target object is different from the depth value of the original background, the pixel point of the target object and the pixel point of the original background may be determined based on the depth value corresponding to each pixel point in the target depth image. Then the target depth image is segmented to obtain the target object template image including the pixel point of the image corresponding to the target object and obtained through segmentation. The target object template image includes only the target object wearing the first device, and does not include any of the original background. Operation S120 may be understood as performing image matting on the target object wearing the first device.

S130: Obtain M background images corresponding to a target scene.

The target scene is a scene set based on a training task, and M is an integer greater than or equal to 1.

The M background images are set based on the training task.

S140: Superimpose the target object template image on the M background images to generate M target scene images.

The target scene image is configured for presenting an image of the target object wearing the first device in the target scene.

The target object template image obtained through image matting in operation S120 is superimposed on the plurality of background images to generate the plurality of target scene images. The target scene image includes the target object wearing the first device and the background images. Operation S140 may be understood as performing background superimposition on the target object template image that is of the target object wearing the first device and that is obtained through image matting, to generate the target object with a virtual background. The virtual background herein refers to that the target object has not been shot in the scene.

The M generated target scene images are used as training data to train a mixed reality recording model. This application provides performing, through picture synthesis, mass production of training images. Specifically, a basic picture including a target object is first obtained, and image matting is performed on the basic picture to obtain a template picture including only the target object. For example, if the target object is a portrait, the basic picture is processed by using a portrait segmentation technology to obtain a template picture including only the target object. Then, background superimposition is performed on the template picture, to generate training images in batches. A method for generating a training image provided according to this method can resolve problems of insufficient training samples and poor training sample quality.

According to the image generation method provided in this application, the target depth image that includes the target object is segmented to obtain the target object template image. Then, a large quantity of training images with different backgrounds are generated by superimposing the target object template image on a large quantity of different background images. The large quantity of training images are obtained with minimum costs, quality of each training image is ensured through combination of a target object template and a background, and training efficiency and accuracy of an image processing model are effectively improved.

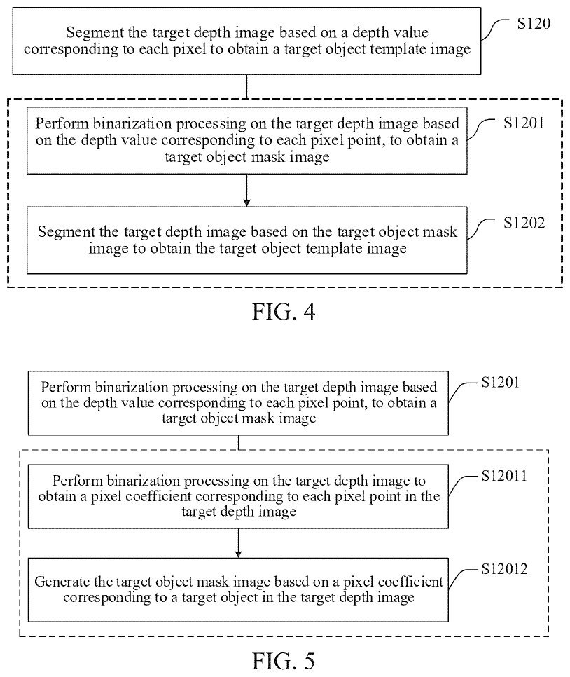

In an embodiment of the image generation method provided in the embodiment corresponding to FIG. 2 of this application, referring to FIG. 4, operation S120 includes sub-operation S1201 and sub-operation S1202. Details are as follows:

S1201: Perform binarization processing on the target depth image based on the depth value corresponding to each pixel point, to obtain a target object mask image.

A pixel point corresponding to the target object wearing the first device and a pixel point corresponding to the original background are determined based on the depth value corresponding to each pixel point. A first numerical value is assigned to the pixel point corresponding to the target object wearing the first device, and a second numerical value is assigned to the pixel point corresponding to the original background. Preferably, the first numerical value is 1, and the second numerical value is 0. An image including the first numerical value and the second numerical value is used as the target object mask image.

S1202: Segment the target depth image based on the target object mask image to obtain the target object template image.

The target object mask image is multiplied by a corresponding position in the target depth image. The first numerical value, which is 1, is multiplied by the pixel point in the target depth image, to obtain the pixel point in the target depth image. That is, the pixel point corresponding to the target object is retained. The second numerical value, which is 0, is multiplied by the pixel point in the target depth image. That is, the pixel point is removed.

According to the image generation method provided in this application, binarization processing is performed on the target depth image based on the depth value of each pixel point, to generate the target object mask image. The target depth image is processed based on the target object mask image to obtain the target object template image. In this way, accuracy of generating the target object template image is improved, noise data of the target object template image is reduced, and quality of the target object template image is improved.

In an embodiment of the image generation method provided in the embodiment corresponding to FIG. 4 of this application, referring to FIG. 5, sub-operation S1201 further includes sub-operation S12011 and sub-operation S12012. Details are as follows:

S12011: Perform binarization processing on the target depth image to obtain a pixel coefficient corresponding to each pixel point in the target depth image.

In other words, after binarization processing is performed based on the depth value of each pixel point, pixel points with depth values in different depth ranges are assigned with different values, so that a foreground part and a background part in the target depth image can be effectively distinguished, and are annotated differently by using the pixel coefficient.

Binarization processing is performed on the target depth image, a first pixel coefficient is assigned to the pixel point corresponding to the target object wearing the first device, and a second pixel coefficient is assigned to the pixel point corresponding to the original background. Preferably, the first pixel coefficient is 1, and the second pixel coefficient is 0. The pixel coefficient corresponding to each pixel point in the target depth image is obtained.

S12012: Generate the target object mask image based on a pixel coefficient corresponding to the target object in the target depth image.

An image including the first pixel coefficient and the second pixel coefficient is used as the target object mask image.

According to the image generation method provided in this application, binarization processing is performed on the target depth image to obtain the pixel coefficient corresponding to each pixel point in the target depth image. Then, the target object mask image is generated based on the pixel coefficient corresponding to the target object. In this way, accuracy of generating the target object mask image is improved, noise data of the target object mask image is reduced, and quality of the target object mask image is improved.

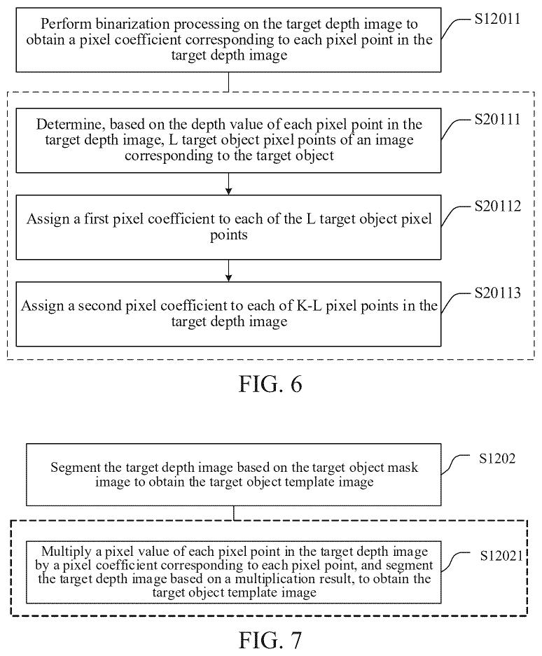

In an embodiment of the image generation method provided in the embodiment corresponding to FIG. 5 of this application, referring to FIG. 6, the target depth image includes K pixel points, where K is an integer greater than 1. Sub-operation S12011 further includes sub-operation S20111 to sub-operation S20113. Details are as follows:

S20111: Determine, based on the depth value of each pixel point in the target depth image, L target object pixel points of an image corresponding to the target object.

L is an integer greater than 1 and less than K.

Because a distance between the target object in the target depth image and the depth camera is different from a distance between the original background and the depth camera, a depth value of the pixel point corresponding to the target object is different from a depth value of the pixel point corresponding to the original background. Therefore, the L target object pixel points of the image corresponding to the target object may be determined based on the depth value of each pixel point in the target depth image.

It can be learned that, because the target object used as the foreground and the original background are significantly different in the depth values, the following may be determined based on the depth values: the L target object pixel points with small depth values are configured for determining the pixel point corresponding to the target object, and the K-L pixel points with large depth values are configured for identifying the original background other than the target object in the target depth image.

S20112: Assign the first pixel coefficient to each of the L target object pixel points.

The first pixel coefficient is assigned to the L target object pixel points, that is, the first pixel coefficient is assigned to the pixel point corresponding to the target object.

Preferably, the first pixel coefficient is 1.

S20113: Assign the second pixel coefficient to each of the K-L pixel points in the target depth image.

The second pixel coefficient is assigned to each of the K-L pixel points in the target depth image, that is, the second pixel coefficient is assigned to the K-L pixel points corresponding to the original background. Preferably, the second pixel coefficient is 0.

According to the image generation method provided in this application, binarization processing is performed on the target depth image to obtain the pixel coefficient corresponding to each pixel point in the target depth image. Because the target object used as the foreground and the original background are significantly different in the depth values, the pixel points of the target object and the original background can be accurately distinguished based on the depth values, and different pixel coefficients are annotated differently. Then, the target object mask image is generated based on the pixel coefficient corresponding to the target object. In this way, accuracy of generating the target object mask image is improved, noise data of the target object mask image is reduced, and quality of the target object mask image is improved.

In an embodiment of the image generation method provided in the embodiment corresponding to FIG. 5 of this application, referring to FIG. 7, sub-operation S1202 further includes sub-operation S12021. Details are as follows:

S12021: Multiply a pixel value of each pixel point in the target depth image by the pixel coefficient corresponding to each pixel point, and segment the target depth image based on a multiplication result, to obtain the target object template image.

Because the first pixel coefficient and the second pixel coefficient are different in numerical values, the target object template image can be accurately segmented from the target depth image based on the multiplication result by multiplying the first pixel coefficient and the second pixel coefficient by the pixel values of the pixel points. For example, a pixel coefficient of a pixel point is the first pixel coefficient, a numerical value of the first pixel coefficient is 1, and a pixel value of the pixel point remains unchanged through multiplication. A pixel coefficient of a pixel point is the second pixel coefficient, a numerical value of the second pixel coefficient is 0, and a pixel value of the pixel point is 0 through multiplication. Therefore, pixel points whose pixel values are 0 may be removed from the target depth image, and remaining pixel points are the target object template image.

According to the image generation method provided in this application, binarization processing is performed on the target depth image, to generate the target object mask image. The target depth image is segmented based on the target object mask image to obtain the target object template image. In this way, accuracy of generating the target object template image is improved, noise data of the target object template image is reduced, and quality of the target object template image is improved.

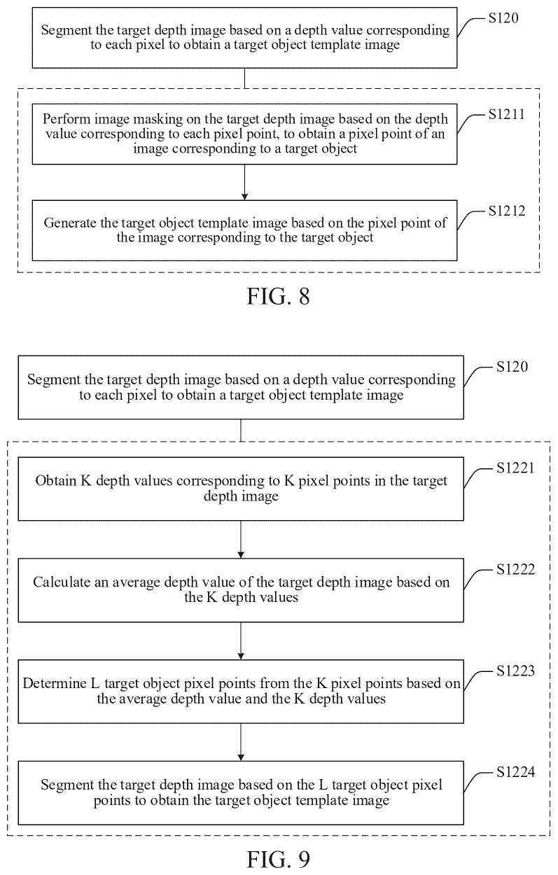

In an embodiment of the image generation method provided in the embodiment corresponding to FIG. 2 of this application, referring to FIG. 8, operation S120 further includes sub-operation S1211 and sub-operation S1212. Details are as follows:

S1211: Perform image masking on the target depth image based on the depth value corresponding to each pixel point, to obtain a pixel point of an image corresponding to the target object.

Image masking is performed on the target depth image based on the depth value corresponding to each pixel point, to be specific, a first numerical value is assigned to a pixel point corresponding to a first depth value, and a second numerical value is assigned to a pixel point corresponding to a second depth value, where preferably, the first numerical value is 1, and the second numerical value is 0, to obtain the pixel point of the image corresponding to the target object.

S1212: Generate the target object template image based on the pixel point of the image corresponding to the target object.

The target object mask image is multiplied by a corresponding position in the target depth image. The first numerical value, which is 1, is multiplied by the corresponding pixel point in the target depth image, to obtain the pixel point of the target object. The second numerical value, which is 0, is multiplied by the pixel point in the target depth image, that is, the pixel point (the original background) is removed.

According to the image generation method provided in this application, image masking is performed on the target depth image, to obtain the pixel point of an image corresponding to the target object. Then, the target object mask image is generated based on the pixel points of the image corresponding to the target object. The target depth image is processed based on the target object mask image to obtain the target object template image. In this way, accuracy of generating the target object template image is improved, noise data of the target object template image is reduced, and quality of the target object template image is improved.

In an embodiment of the image generation method provided in the embodiment corresponding to FIG. 2 of this application, referring to FIG. 9, operation S120 further includes sub-operation S1221 to sub-operation S1224. Details are as follows:

S1221: Obtain K depth values corresponding to K pixel points in the target depth image.

The depth value corresponding to each pixel point in the target depth image is obtained.

S1222: Calculate an average depth value of the target depth image based on the K depth values.

An average of the K depth values is calculated as the average depth value of the target depth image.

S1223: Determine L target object pixel points from the K pixel points based on the average depth value and the K depth values.

Because the depth value of the pixel point corresponding to the target object is less than the average depth value, the L target object pixel points are determined from the K pixel points based on the average depth value and the K depth values.

S1224: Segment the target depth image based on the L target object pixel points to obtain the target object template image.

The target object template image is generated based on the target object pixel points.

It can be learned that the average depth value may reflect an average distance between an image capture position and objects (for example, the foreground and the background) in the target depth image. Because the foreground and the background are generally significantly different in the depth values, the average depth value may be used as a measurement standard to accurately distinguish between the foreground and the background in the target depth image.

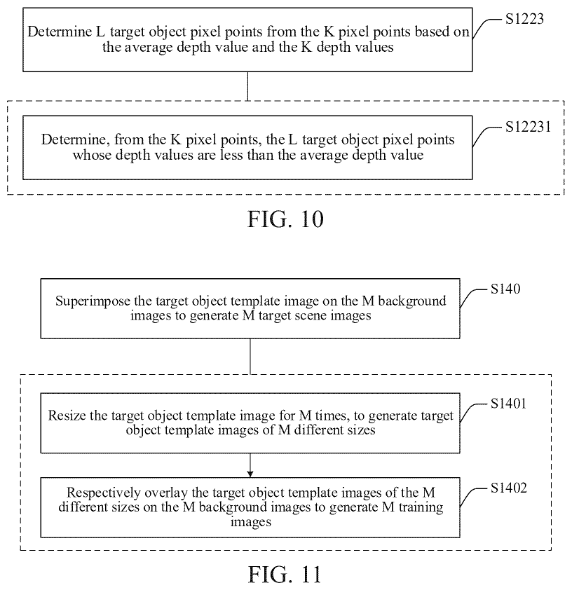

In an embodiment of the image generation method provided in the embodiment corresponding to FIG. 9 of this application, referring to FIG. 10, sub-operation S1223 further includes sub-operation S12231. Details are as follows:

S12231: Determine, from the K pixel points, the L target object pixel points whose depth values are less than the average depth value.

Because the distance between the target object and the depth camera is less than the distance between the original background and the depth camera, the depth value of the pixel point corresponding to the target object is less than the depth value of the pixel point corresponding to the original background. Therefore, the depth value of the pixel point corresponding to the target object is less than the average depth value. In this way, the target object pixel points may be determined based on a magnitude relationship between the depth value of each pixel point and the average depth value.

In an embodiment of the image generation method provided in the embodiment corresponding to FIG. 2 of this application, referring to FIG. 11, operation S140 further includes sub-operation S1401 and sub-operation S1402. Details are as follows:

S1401: Resize the target object template image for M times, to generate target object template images of M different sizes.

The M different sizes are all less than sizes of the M background images.

The target object template image is replicated to obtain M target object template images. Each of the M target object template images is resized, so that sizes of the M target object template images are different.

S1402: Respectively overlay the target object template images of the M different sizes on the M background images to generate M training images.

The target object template images of the M different sizes are spliced with the M background images. The target object template images of the M different sizes are overlaid on the M background images to generate the M training images.

According to the image generation method provided in this application, the target object template images of the M different sizes are overlaid on the M background images to generate the M training images. A large quantity of training images are obtained with minimum costs, and quality of each training image is ensured through combination of a target object template and a background, and training efficiency and accuracy of an image processing model are effectively improved.

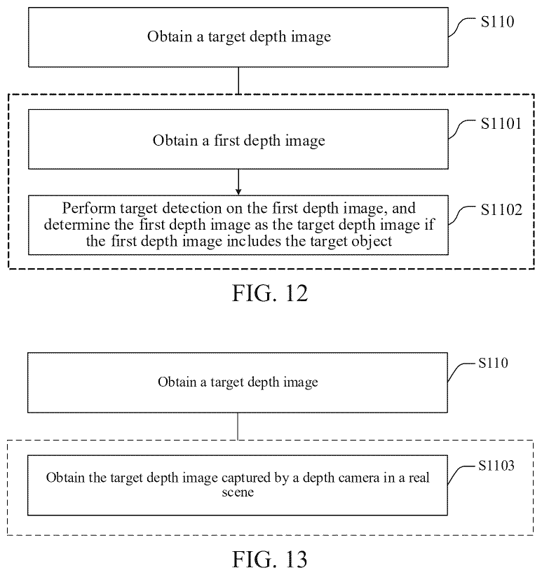

In an embodiment of the image generation method provided in the embodiment corresponding to FIG. 2 of this application, referring to FIG. 12, operation S110 further includes sub-operation S1101 and sub-operation S1102. Details are as follows:

S1101: Obtain a first depth image.

S1102: Perform target detection on the first depth image, and determine the first depth image as the target depth image if the first depth image includes the target object.

The depth camera obtains the first depth image, and target object detection is performed on the first depth image. If the first depth image includes the target object wearing the first device, the first depth image is determined as the target depth image.

In the foregoing scenario related to wearing a device, through target detection for the target object and the first device, an image including the target object wearing the first device can be accurately screened out from the first depth image, and an image including only the first device or only the target object can be excluded, so that precision of determining the target depth image is improved.

In an embodiment of the image generation method provided in the embodiment corresponding to FIG. 2 of this application, referring to FIG. 13, sub-operation S110 further includes sub-operation S1103. Details are as follows:

S1103: Obtain the target depth image captured by the depth camera in the real scene.

The real scene includes the target object and a real background.

The depth camera is used to shoot the target object or the target object wearing the first device in the real scene, so that a relative position relationship between the target object and the depth camera can be configured in a targeted manner during shooting, to distinguish between the foreground and the background in the depth values, thereby facilitating subsequent segmentation of the target object template image.

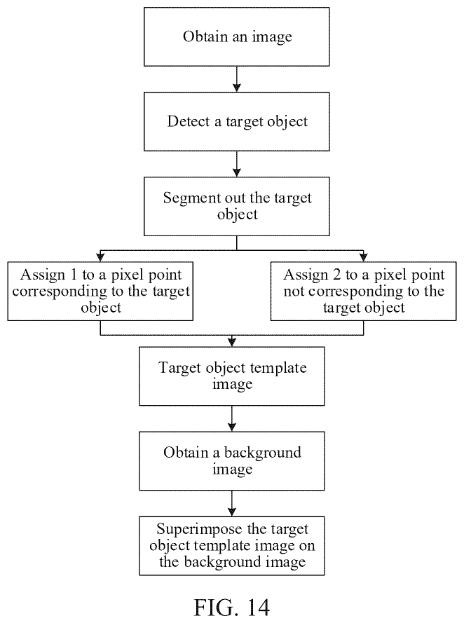

For ease of understanding, an image generation method is described below with reference to FIG. 14. First, a first depth image shot by a depth camera is obtained. Then, target detection is performed on the first depth image. If the first depth image includes a target object wearing a first device, the target object is segmented out, where a pixel point corresponding to the target object is assigned with a value 1, and a pixel point not corresponding to the target object is assigned with a value 2, to obtain a target object template image. Then, M background images are obtained. Finally, the target object template image is superimposed on the M background images to generate M target scene images.

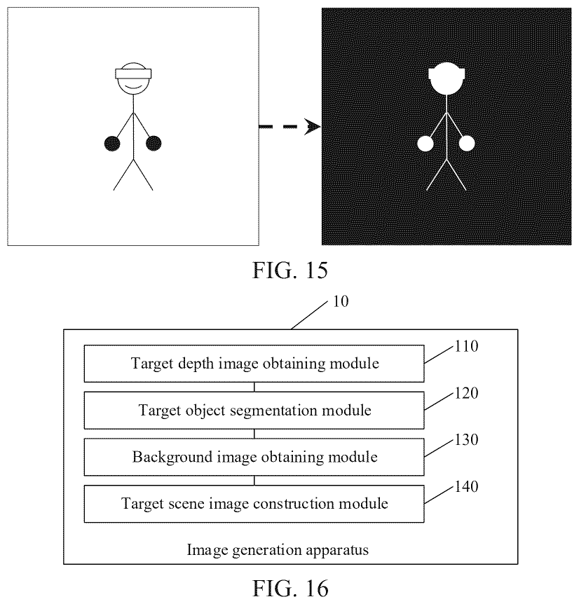

An example in which a human body with a helmet and a handle is used as the target object wearing the first device is used for description. FIG. 15 is a schematic diagram of target segmentation according to an embodiment of this application. A task of segmenting the human body with the helmet is used as an example. A target depth image is captured by using the depth camera. During capture of the target depth image, a plane with a flat surface and without other decoration is set as an original background, to enable background depths to be as same as possible or float in a range close to a value. To further narrow the floating range of the background depths, the capture device is placed at a maximum capture distance of the capture device. Finally, the person with the helmet and the handle is located at ⅔ of a distance between the device and the background because the background and the human body can be better distinguished in depths at this distance on the premise that it is ensured that the human body is entirely included in the image. Then, as shown in FIG. 15, the target depth image captured according to this process is post-processed through binarization, so that the target depth image can be changed into a mask of the human body with glasses and the handle. A reason for using the binarization is that, for the task of segmenting the human body, only two categories of masks are required: human and non-human. Therefore, classification through the binarization is most intuitive. Regardless of visualizing a result or applying a generated result to final body segmentation, a binarized mask is very convenient to use. For example, when a mask with only 0 and 1 is used, image matting may be performed on the human body by multiplying the mask by an input image. Then, a corresponding main element of the human body is extracted from the original image by using the mask obtained in the foregoing operations, and all other information is removed. A specific operation is to superimpose the mask on the original image, to directly remove pixels whose depth values are in the range of the background depth from the original image, and remaining pixels are the human body. In this way, the human body element in the original image can be extracted by using a highly accurate contour captured by a hardware capture device.

$$mask value = \{ \begin{matrix}current depth < background depth , 1 \\ otherwise , 0\end{matrix} ;$$

mask value represents binarization processing, a depth value (current depth) of the pixel point corresponding to the target object is less than a depth value (background depth) of a pixel point corresponding to the original background, the pixel point corresponding to the target object is assigned with 1, and a pixel point other than the pixel point corresponding to the target object is assigned with 0.

Finally, the foregoing obtained main element of segmenting the human body with the helmet and the handle is superimposed onto different types of scenes through different degrees of transformation, to implement a form of one-to-many dataset construction.

$$result ( x , y ) = mask ( x , y ) * ori ( x , y ) + background ( x , y ) ;$$

A target object mask image (mask(x,y)) is multiplied by the target depth image (ori(x,y)) and then is superimposed on the background image (background(x,y)), to obtain the target scene image.

The method provided in this embodiment of this application can resolve a problem that it is difficult to implement model research and preliminary solution verification that are important operations in a task with a small quantity of published data sources. In the method provided in this embodiment of this application, a true value of a target can be captured by using an external hardware device with high precision, and then a large amount of data is obtained through fusing by superimposing different condition factors, so that objectives of low costs and a large data amount are achieved, and the method has wide application promise.

The following describes an image generation apparatus in this application in detail. FIG. 16 is a schematic diagram of an image generation apparatus 10 according to an embodiment of this application. The image generation apparatus 10 includes:
a target depth image obtaining module 110, configured to obtain a target depth image, where the target depth image is configured for presenting a target object in a real scene, and each pixel point in the target depth image has a depth value;
a target object segmentation module 120, configured to segment the target depth image based on the depth value corresponding to each pixel point, to obtain a target object template image, where the target object template image includes a pixel point corresponding to the target object in the target depth image;
a background image obtaining module 130, configured to obtain M background images corresponding to a target scene, where the target scene is a scene set based on a training task, and M is an integer greater than or equal to 1;
a target scene image construction module 140, configured to superimpose the target object template image on the M background images to generate M target scene images, where the target scene image is configured for presenting the target object in the target scene.

According to the image generation apparatus provided in this application, the target depth image that includes the target object is segmented to obtain the target object template image. Then, a large quantity of training images with different backgrounds are generated by superimposing the target object template image on a large quantity of different background images. The large quantity of training images are obtained with minimum costs, quality of each training image is ensured through combination of a target object template and a background, and training efficiency and accuracy of an image processing model are effectively improved.

In an embodiment of the image generation apparatus provided in the embodiment corresponding to FIG. 16 of this application, the target object segmentation module 120 is further configured to:
perform binarization processing on the target depth image based on the depth value corresponding to each pixel point, to obtain a target object mask image; and
segment the target depth image based on the target object mask image to obtain the target object template image.

According to the image generation apparatus provided in this application, binarization processing is performed on the target depth image, to generate the target object mask image. The target depth image is processed based on the target object mask image to obtain the target object template image. In this way, accuracy of generating the target object template image is improved, noise data of the target object template image is reduced, and quality of the target object template image is improved.

In an embodiment of the image generation apparatus provided in the embodiment corresponding to FIG. 16 of this application, the target object segmentation module 120 is further configured to:
perform binarization processing on the target depth image to obtain a pixel coefficient corresponding to each pixel point in the target depth image; and
generate the target object mask image based on a pixel coefficient corresponding to the target object in the target depth image.

According to the image generation apparatus provided in this application, binarization processing is performed on the target depth image to obtain the pixel coefficient corresponding to each pixel point in the target depth image. Then, the target object mask image is generated based on the pixel coefficient corresponding to the target object. In this way, accuracy of generating the target object mask image is improved, noise data of the target object mask image is reduced, and quality of the target object mask image is improved.

In an embodiment of the image generation apparatus provided in the embodiment corresponding to FIG. 16 of this application, the target depth image includes K pixel points, where K is an integer greater than 1. The target object segmentation module 120 is further configured to:
determine, based on the depth value of each pixel point in the target depth image, L target object pixel points of an image corresponding to the target object, where Lis an integer greater than 1 and less than K;
assign a first pixel coefficient to each of the L target object pixel points; and
assign a second pixel coefficient to each of K-L pixel points in the target depth image.

According to the image generation apparatus provided in this application, binarization processing is performed on the target depth image to obtain the pixel coefficient corresponding to each pixel point in the target depth image. Then, the target object mask image is generated based on the pixel coefficient corresponding to the target object. In this way, accuracy of generating the target object mask image is improved, noise data of the target object mask image is reduced, and quality of the target object mask image is improved.

In an embodiment of the image generation apparatus provided in the embodiment corresponding to FIG. 16 of this application, the target object segmentation module 120 is further configured to:
multiply a pixel value of each pixel point in the target depth image by the pixel coefficient corresponding to each pixel point, and segment the target depth image based on a multiplication result, to obtain the target object template image.

According to the image generation apparatus provided in this application, binarization processing is performed on the target depth image, to generate the target object mask image. The target depth image is processed based on the target object mask image to obtain the target object template image. In this way, accuracy of generating the target object template image is improved, noise data of the target object template image is reduced, and quality of the target object template image is improved.

In an embodiment of the image generation apparatus provided in the embodiment corresponding to FIG. 16 of this application, the target object segmentation module 120 is further configured to:
perform image masking on the target depth image based on the depth value corresponding to each pixel point, to obtain a pixel point of an image corresponding to the target object; and
generate the target object template image based on the pixel point of the image corresponding to the target object.

According to the image generation apparatus provided in this application, image masking is performed on the target depth image, to obtain the pixel point of an image corresponding to the target object. Then, the target object mask image is generated based on the pixel points of the image corresponding to the target object. The target depth image is processed based on the target object mask image to obtain the target object template image. In this way, accuracy of generating the target object template image is improved, noise data of the target object template image is reduced, and quality of the target object template image is improved.

In an embodiment of the image generation apparatus provided in the embodiment corresponding to FIG. 16 of this application, the target object segmentation module 120 is further configured to:
obtain K depth values corresponding to K pixel points in the target depth image;
calculate an average depth value of the target depth image based on the K depth values;
determine L target object pixel points from the K pixel points based on the average depth value and the K depth values; and
segment the target depth image based on the L target object pixel points to obtain the target object template image.

According to the image generation method provided in this application, the pixel point corresponding to the target object is obtained by comparing the depth value of each pixel point with the average depth value, to generate the target object template image. Then, a large quantity of training images with different backgrounds are generated by superimposing the target object template image on a large quantity of different background images. The large quantity of training images are obtained with minimum costs, quality of each training image is ensured through combination of a target object template and a background, and training efficiency and accuracy of an image processing model are effectively improved.

In an embodiment of the image generation apparatus provided in the embodiment corresponding to FIG. 16 of this application, the target object segmentation module 120 is further configured to:
determine, from the K pixel points, the L target object pixel points whose depth values are less than the average depth value.

According to the image generation apparatus provided in this application, the pixel point whose depth value is less than the average depth value is determined to be the pixel point corresponding to the target object, by comparing the depth value of each pixel point with the average depth value.to generate the target object template image. Then, a large quantity of training images with different backgrounds are generated by superimposing the target object template image on a large quantity of different background images. The large quantity of training images are obtained with minimum costs, quality of each training image is ensured through combination of a target object template and a background, and training efficiency and accuracy of an image processing model are effectively improved.

In an embodiment of the image generation apparatus provided in the embodiment corresponding to FIG. 16 of this application, the target scene image construction module 140 is further configured to:
resize the target object template image for M times, to generate target object template images of M different sizes, where the M different sizes are all less than sizes of the M background images; and
respectively overlay the target object template images of the M different sizes on the M background images to generate M training images.

According to the image generation apparatus provided in this application, the target object template images of the M different sizes are overlaid on the M background images to generate the M training images. A large quantity of training images are obtained with minimum costs, and quality of each training image is ensured through combination of a target object template and a background, and training efficiency and accuracy of an image processing model are effectively improved.

In an embodiment of the image generation apparatus provided in the embodiment corresponding to FIG. 16 of this application, the target depth image obtaining module 110 is further configured to:
obtain a first depth image; and
perform target detection on the first depth image, and determine the first depth image as the target depth image if the first depth image includes the target object wearing a first device.

According to the image generation method provided in this application, target detection is performed on the first depth image captured by a depth camera, to determine the target depth image including the target object wearing the first device. The target depth image that includes the target object is segmented to obtain the target object template image. Then, a large quantity of training images with different backgrounds are generated by superimposing the target object template image on a large quantity of different background images. The large quantity of training images are obtained with minimum costs, quality of each training image is ensured through combination of a target object template and a background, and training efficiency and accuracy of an image processing model are effectively improved.

In an embodiment of the image generation apparatus provided in the embodiment corresponding to FIG. 16 of this application, the target depth image obtaining module 110 is further configured to:
obtain the target depth image captured by the depth camera in the real scene, where the real scene includes the target object and a real background.

According to the image generation method provided in this application, target detection is performed on the first depth image captured by the depth camera, to determine the target depth image including the target object wearing the first device. The target depth image that includes the target object is segmented to obtain the target object template image. Then, a large quantity of training images with different backgrounds are generated by superimposing the target object template image on a large quantity of different background images. The large quantity of training images are obtained with minimum costs, quality of each training image is ensured through combination of a target object template and a background, and training efficiency and accuracy of an image processing model are effectively improved.

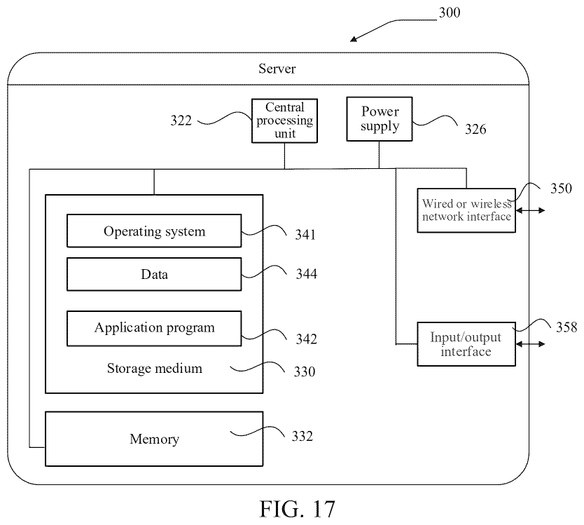

FIG. 17 is a schematic diagram of a structure of a server according to an embodiment of this application. A server 300 may vary greatly due to different configurations or performance, and may include one or more central processing units (CPUs) 322 (for example, one or more processors), a memory 332, and one or more storage media 330 (for example, one or more mass storage devices) that store an application program 342 or data 344. The memory 332 and the storage medium 330 may be configured for transient storage or persistent storage. The program stored in the storage medium 330 may include one or more modules (that are not shown in the figure), and each module may include a series of operations on the server. Further, the central processing unit 322 may be configured to communicate with the storage medium 330, and execute, on the server 300, the series of operations in the storage medium 330.

The server 300 may further include one or more power supplies 326, one or more wired or wireless network interfaces 350, one or more input/output interfaces 358, and/or one or more operating systems 341, for example, Windows Server™, Mac OS X™, Unix™, Linux™, FreeBSD™, and the like.

Operations performed by the server in the foregoing embodiments may be based on the structure of the server shown in FIG. 17.

In addition, an embodiment of this application further provides a storage medium. The storage medium is configured to store a computer program. The computer program is configured to perform the method provided in the foregoing embodiments.

An embodiment of this application further provides a computer program product including a computer program. When the computer program product is run on a computer, the computer is enabled to perform the method provided in the foregoing embodiments.

A person skilled in the art may clearly understand that, for convenience and conciseness of description, for specific working processes of the foregoing described system, apparatus and unit, refer to the corresponding processes in the foregoing method embodiments, and details are not described herein again.

In the several embodiments provided in this application, the disclosed system, apparatus, and method may be implemented in other manners. For example, the described apparatus embodiment is merely an example. For example, the unit division is merely logical function division and there may be other division during actual implementation. For example, a plurality of units or components may be combined or integrated into another system, or some features may be ignored or not performed. In addition, the mutual couplings, direct couplings or communication connections that are displayed or discussed may be indirect couplings or communication connections through some interfaces, apparatuses or units, or may be implemented in electronic, mechanical, or other forms.

The units described as separate parts may or may not be physically separated, and parts displayed as units may or may not be physical units, that is, may be located in one position, or may be distributed on a plurality of network units. Some or all of the units may be selected based on actual needs to achieve the objectives of the solutions of the embodiments.

In addition, the function units in the embodiments of this application may be integrated into one processing unit, or each of the units may exist alone physically, or two or more units are integrated into one unit. The foregoing integrated unit may be implemented in a form of hardware, or may be implemented in a form of a software function unit.

When the integrated unit is implemented in the form of the software function unit, and sold or used as an independent product, the integrated unit may be stored in a non-transitory computer-readable storage medium. Based on this understanding, the technical solutions of this application essentially, or the part contributing to the related art, or all or some of the technical solutions may be implemented in the form of a software product. The computer software product is stored in a storage medium and includes several instructions for instructing a computer device (which may be a personal computer, a server, a network device, or the like) to perform all or some of the operations of the methods in the embodiments of this application. The foregoing storage medium includes any medium that can store program code, such as a universal serial bus (USB) flash drive, a removable hard disk, a read-only memory (ROM), a random access memory (RAM), a magnetic disk, or an optical disc.

In this application, the term “module” or “unit” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module or unit can be implemented using one or more processors (or processors and memory). Likewise, a processor (or processors and memory) can be used to implement one or more modules or units. Moreover, each module or unit can be part of an overall module or unit that includes the functionalities of the module or unit. The foregoing embodiments are merely used for describing the technical solutions of this application, but are not intended to limit this application. Although this application is described in detail with reference to the foregoing embodiments, a person of ordinary skill in the art is to understand that modifications may still be made to the technical solutions described in the foregoing embodiments or equivalent replacements may be made to some technical features thereof, and these modifications or replacements do not cause the essence of corresponding technical solutions to depart from the spirit and scope of the technical solutions in the embodiments of this application.

What is claimed is:

1. An image generation method performed by a computer device, and comprising:
obtaining a target depth image, the target depth image including a target object in a real scene, and each pixel point in the target depth image having a depth value;
segmenting the target depth image based on the depth value corresponding to each pixel point in the target depth image, to obtain a target object template image, the target object template image comprising a plurality of pixel points corresponding to the target object in the target depth image;
obtaining M background images corresponding to a target scene, the target scene being a scene set associated with an image processing model, and M being an integer greater than or equal to 1; and
superimposing the target object template image on the M background images, to generate M target scene images, the target scene images being configured for training the image processing model.

2. The image generation method according to claim 1, wherein the segmenting the target depth image based on the depth value corresponding to each pixel point in the target depth image, to obtain a target object template image comprises:
performing binarization processing on the target depth image based on the depth value corresponding to each pixel point in the target depth image, to obtain a target object mask image; and
segmenting the target depth image based on the target object mask image to obtain the target object template image.

3. The image generation method according to claim 2, wherein the performing binarization processing on the target depth image, to obtain a target object mask image comprises:
performing binarization processing on the target depth image to obtain a pixel coefficient corresponding to each pixel point in the target depth image; and
generating the target object mask image based on a pixel coefficient corresponding to the target object in the target depth image.

4. The image generation method according to claim 3, wherein the target depth image comprises K pixel points, and K is an integer greater than 1; and
the performing binarization processing on the target depth image to obtain a pixel coefficient corresponding to each pixel point in the target depth image comprises:
determining, based on the depth value of each pixel point in the target depth image, L target object pixel points of an image corresponding to the target object, L being an integer greater than 1 and less than K;
assigning a first pixel coefficient to each of the L target object pixel points; and
assigning a second pixel coefficient to each of K-L pixel points in the target depth image.

5. The image generation method according to claim 3, wherein the segmenting the target depth image based on the target object mask image to obtain the target object template image comprises:
multiplying a pixel value of each pixel point in the target depth image by the pixel coefficient corresponding to each pixel point, and segmenting the target depth image based on a multiplication result, to obtain the target object template image.

6. The image generation method according to claim 1, wherein the segmenting the target depth image based on the depth value corresponding to each pixel point in the target depth image, to obtain a target object template image comprises:
performing image masking on the target depth image based on the depth value corresponding to each pixel point in the target depth image, to obtain a plurality of pixel points of an image corresponding to the target object; and
generating the target object template image based on the plurality of pixel points of the image corresponding to the target object.

7. The image generation method according to claim 1, wherein the segmenting the target depth image based on the depth value corresponding to each pixel point in the target depth image, to obtain a target object template image comprises:
obtaining K depth values corresponding to K pixel points in the target depth image;
calculating an average depth value of the target depth image based on the K depth values;
determining L target object pixel points from the K pixel points based on the average depth value and the K depth values; and
segmenting the target depth image based on the L target object pixel points to obtain the target object template image.

8. The image generation method according to claim 7, wherein the determining L target object pixel points from the K pixel points based on the average depth value and the K depth values comprises:
determining, from the K pixel points, the L target object pixel points whose depth values are less than the average depth value.

9. The image generation method according to claim 1, wherein the superimposing the target object template image on the M background images, to generate M target scene images comprises:
resizing the target object template image for M times, to generate target object template images of M different sizes, the M different sizes being all less than sizes of the M background images; and
respectively overlaying the target object template images of the M different sizes on the M background images to generate M training images.

10. The image generation method according to claim 1, wherein the obtaining a target depth image comprises:
obtaining a first depth image;
performing target detection on the first depth image, and determining the first depth image as the target depth image if the first depth image comprises the target object.

11. The image generation method according to claim 1, wherein the obtaining a target depth image comprises:
obtaining the target depth image captured by a depth camera in the real scene, the real scene comprising the target object and a real background.

12. A computer device, comprising: a memory, a transceiver, and a processor;
the memory being configured to store a plurality of computer programs;
the processor being configured to execute the plurality of computer programs in the memory to perform an image generation method including:
obtaining a target depth image, the target depth image including a target object in a real scene, and each pixel point in the target depth image having a depth value;
segmenting the target depth image based on the depth value corresponding to each pixel point in the target depth image, to obtain a target object template image, the target object template image comprising a plurality of pixel points corresponding to the target object in the target depth image;
obtaining M background images corresponding to a target scene, the target scene being a scene set associated with an image processing model, and M being an integer greater than or equal to 1; and
superimposing the target object template image on the M background images, to generate M target scene images, the target scene images being configured for training the image processing model.

13. The computer device according to claim 12, wherein the segmenting the target depth image based on the depth value corresponding to each pixel point in the target depth image, to obtain a target object template image comprises:
performing binarization processing on the target depth image based on the depth value corresponding to each pixel point in the target depth image, to obtain a target object mask image; and
segmenting the target depth image based on the target object mask image to obtain the target object template image.

14. The computer device according to claim 12, wherein the segmenting the target depth image based on the depth value corresponding to each pixel point in the target depth image, to obtain a target object template image comprises:
performing image masking on the target depth image based on the depth value corresponding to each pixel point in the target depth image, to obtain a plurality of pixel points of an image corresponding to the target object; and
generating the target object template image based on the plurality of pixel points of the image corresponding to the target object.

15. The computer device according to claim 12, wherein the segmenting the target depth image based on the depth value corresponding to each pixel point in the target depth image, to obtain a target object template image comprises:
obtaining K depth values corresponding to K pixel points in the target depth image;
calculating an average depth value of the target depth image based on the K depth values;
determining L target object pixel points from the K pixel points based on the average depth value and the K depth values; and
segmenting the target depth image based on the L target object pixel points to obtain the target object template image.

16. The computer device according to claim 12, wherein the superimposing the target object template image on the M background images, to generate M target scene images comprises:
resizing the target object template image for M times, to generate target object template images of M different sizes, the M different sizes being all less than sizes of the M background images; and
respectively overlaying the target object template images of the M different sizes on the M background images to generate M training images.

17. The computer device according to claim 12, wherein the obtaining a target depth image comprises:
obtaining a first depth image;
performing target detection on the first depth image, and determining the first depth image as the target depth image if the first depth image comprises the target object.

18. The computer device according to claim 12, wherein the obtaining a target depth image comprises:
obtaining the target depth image captured by a depth camera in the real scene, the real scene comprising the target object and a real background.

19. A non-transitory computer-readable storage medium, comprising a plurality of computer programs, wherein the plurality of computer programs, when executed by a processor of a computer device, cause the computer device to perform an image generation method including:
obtaining a target depth image, the target depth image including a target object in a real scene, and each pixel point in the target depth image having a depth value;
segmenting the target depth image based on the depth value corresponding to each pixel point in the target depth image, to obtain a target object template image, the target object template image comprising a plurality of pixel points corresponding to the target object in the target depth image;
obtaining M background images corresponding to a target scene, the target scene being a scene set associated with an image processing model, and M being an integer greater than or equal to 1; and
superimposing the target object template image on the M background images, to generate M target scene images, the target scene images being configured for training the image processing model.

20. The non-transitory computer-readable storage medium according to claim 19, wherein the obtaining a target depth image comprises:
obtaining the target depth image captured by a depth camera in the real scene, the real scene comprising the target object and a real background.
